(19) United States
(12) Patent Application Publication
(10) Pub. No.: US 2023/0178716 A1
(43) Pub. Date: Jun. 8, 2023

(54) ANODE CURRENT COLLECTOR INCLUDING DOUBLE COATING LAYER AND ALL-SOLID-STATE BATTERY INCLUDING SAME

(71) Applicants: Hyundai Motor Company, Seoul (KR); Kia Corporation, Seoul (KR)

(72) Inventors: Seung Ho Choi, Hanam (KR); Sang Heon Lee, Yongin (KR)

(21) Appl. No.: 17/987,571

(22) Filed: Nov. 15, 2022

(30) Foreign Application Priority Data
Dec. 6, 2021 (KR) 10-2021-0172513

(51) Int. Cl. H01M 4/36; H01M 4/485; H01M 4/04; H01M 4/40

(52) U.S. Cl. CPC H01M 4/366; H01M 4/0404; H01M 4/405; H01M 4/0407; H01M 4/485; H01M 2004/027

(57) ABSTRACT

Disclosed are an anode current collector including double coating layers and an all-solid-state battery including the anode current collector.

### CROSS REFERENCE TO RELATED APPLICATION

The present application claims priority to Korean Patent Application No. 10-2021-0172513, filed Dec. 6, 2021, the entire contents of which is incorporated herein for all purposes by this reference.

### TECHNICAL FIELD

The present invention relates to an anode current collector including double coating layers and to an all-solid-state battery including the same.

### BACKGROUND

In order to increase the energy density of an all-solid-state battery, an anode-free system may be required. For example, the anode-free system does not include an anode active material layer and stores lithium ions migrating from a cathode active material layer during charging in the form of lithium metal at the interface between an anode current collector and a solid electrolyte layer. However, currently commercially available anode current collectors based on copper (Cu), nickel (Ni), or stainless steel (SUS) do not electrochemically react with lithium ions. The currently available anode current collectors are phobic to lithium. For example, it is difficult for the anode current collector to uniformly store lithium ions thereon during charging. Therefore, an anode current collector coated with a lithiophilic metal has been developed, and it has been reported that lithium can be uniformly deposited.

However, conventional technologies in the related field may have not completely solved the problem of generation of lithium dendrite during charging and discharging because all lithiophilic metals have high electrical conductivity. Electrons freely moving through a metal act as a medium for moving electrons to the surface and inside of a solid electrolyte layer. As a charge or discharge process continues, electrons continue to move into the solid electrolyte layer. As a result, the efficiency per cycle is reduced, and a cell short circuit occurs after several tens of cycles or more.

In addition, most metals spontaneously react with solid electrolytes due to their high chemical reactivity. Therefore, the formation of a lithium-ion transfer layer capable of physically and chemically blocking the interface between the lithiophilic metal and the solid electrolyte layer can improve the overall stability and performance of the all-solid-state battery.

### SUMMARY

In preferred aspects, provided is an all-solid-state battery with improved lifespan and charge and discharge efficiency.

However, the objectives of the present invention are not limited to the one described above. The objectives of the present invention will become more apparent from the following description and will be realized with components recited in the claims and combinations of the components.

In an aspect, provided is an anode current collector for an all-solid-state battery that may include: a current collecting layer; a first coating layer disposed on a first surface of the current collecting layer and including a metal component capable of forming an alloy with lithium; and a second coating layer positioned on the first coating layer and having less electronic conductivity than the first coating layer.

A term “metal component” as used herein refers to an elemental substance or a compound including one or more metals (e.g., alkali metals, alkali earth metals, or transition metals) and one or more other non-metallic elements (e.g., carbon, oxygen, nitrogen, sulfur, phosphorus, hydrogen, or the like). Preferred metal component may form an alloy with lithium, e.g., lithium ions, and form a layer or precipitate.

The first coating layer may include one or more selected from the group consisting of gold (Au), platinum (Pt), silver (Ag), magnesium (Mg), zinc (Zn), aluminum (Al), calcium (Ca), indium (In), and bismuth (Bi).

The first coating layer may have a thickness of about 10 nm to 10 µm.

The second coating layer may include a metal oxide having lithium-ion conductivity.

The second coating layer may suitably include one or more selected from the group consisting of titanium dioxide (TiO₂), silicon dioxide (SiO₂), aluminum oxide (Al₂O₃), cerium oxide (CeO₂), magnesium oxide (MgO), calcium oxide (CaO), zirconium oxide (ZrO₂), and niobium oxide (Nb₂O₅).

The second coating layer may have a thickness of about 10 nm to 100 nm.

In an aspect, provided is all-solid-state battery including: the anode current collector as described herein; a solid electrolyte layer positioned on the anode current collector; a cathode active material layer positioned on the solid electrolyte layer; and a cathode current collector positioned on the cathode active material layer, in which a second coating layer of the anode current collector is in contact with the solid electrolyte layer.

A term “all-solid-state battery” as used herein refers to a rechargeable secondary battery that includes an electrolyte in a solid state, e.g., gel or polymer (cured), which may include an ionomer and other electrolytic components for transferring ions between the electrodes of the battery.

In further aspects, provided herein is a vehicle including the all-solid-state battery of claim as described herein.

When the all-solid-state battery is charged, lithium ions may react with the first coating layer of the anode current collector to form a lithium alloy layer.

According to various exemplary embodiments of the present invention, an all-solid-state battery having good lifespan and good charge and discharge efficiency can be provided.

However, the advantages of the present invention are not limited thereto. It should be understood that the advantages of the present invention include all effects that can be inferred from the description given below.

### BRIEF DESCRIPTION OF THE DRAWINGS

FIG. 1 shows an exemplary all-solid-state battery according to an exemplary embodiment of the present invention;

FIG. 2 shows an exemplary anode current collector according to an exemplary embodiment of the present invention;

FIG. 3 shows a partial configuration of a charging process of an exemplary all-solid-state battery according to an exemplary embodiment of the present invention;

FIG. 4 shows a transmission electron microscopy-energy dispersive spectroscopy (TEM-EDS) analysis result of an anode current collector according to Example 1;

FIG. 5 shows a transmission electron microscopy-energy dispersive spectroscopy (TEM-EDS) analysis result of an anode current collector according to Example 2;

FIG. 6A shows the results of the first charge and discharge cycle of each of the half cells according to Example 1, Example 2 and Comparative Example;

FIG. 6B shows the results of evaluation of the lifespan of each of the half cells according to Example 1 and Comparative Example;

FIG. 6C shows the results of evaluation of the coulombic efficiency for each charge and discharge cycle of each of the half cells according to Example 1 and Comparative Example;

FIG. 7A shows the results of evaluation of the lifespan of each of the half cells according to Examples 3 and 4; and

FIG. 7B shows the results of evaluation of the coulombic efficiency for each charge and discharge cycle of each of the half cells according to Examples 3 and 4.

### DETAILED DESCRIPTION

Above objectives, other objectives, features, and advantages of the present invention will be readily understood from the following preferred embodiments associated with the accompanying drawings. However, the present invention is not limited to the embodiments described herein and may be embodied in other forms. The embodiments described herein are provided so that the invention can be made thorough and complete and that the spirit of the present invention can be fully conveyed to those skilled in the art.

Throughout the drawings, like elements are denoted by like reference numerals. In the accompanying drawings, the dimensions of the structures are larger than actual sizes for clarity of the present invention. Terms used in the specification, “first”, “second”, etc. may be used to describe various components, but the components are not to be construed as being limited to the terms. These terms are used only for the purpose of distinguishing a component from another component. For example, a first component may be referred as a second component, and the second component may be also referred to as the first component. As used herein, the singular forms “a”, “an”, and “the” are intended to include the plural forms as well unless the context clearly indicates otherwise.

It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5,6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

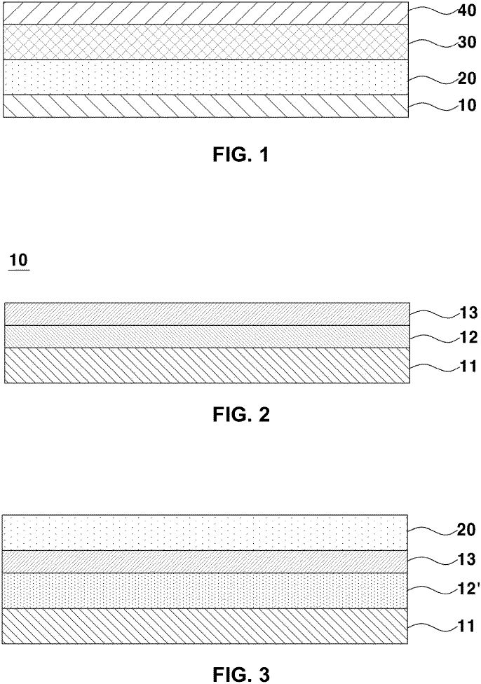

FIG. 1 shows an exemplary all-solid-state battery according to an exemplary embodiment of the present invention. For example, the all-solid-state battery includes an anode current collector 10, a solid electrolyte layer 20 positioned on the anode current collector 10, a cathode active material layer 30 positioned on the solid electrolyte layer 20, and a cathode current collector 40 positioned on the cathode active material layer 30.

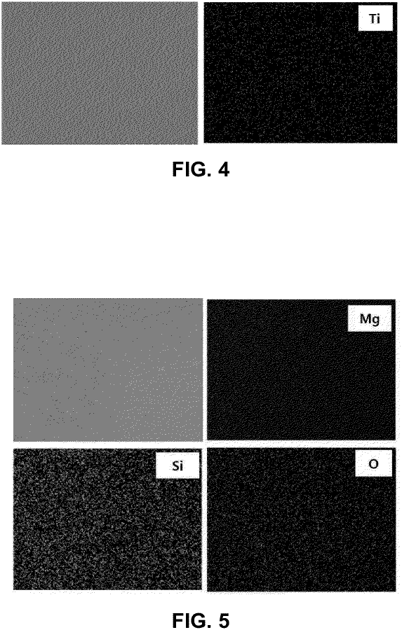

FIG. 2 shows an exemplary anode current collector 10 according to an exemplary embodiment of the present invention. The anode current collector 10 may include a current collecting layer 11, a first coating layer 12 positioned on a first surface of the current collecting layer 11, and a second coating layer 13 positioned on the first coating layer 12.

The current collecting layer 11 may be a plate-shaped, sheet-shaped, or thin-film substrate made of a conductive material. The material constituting the current collecting layer 11 is not particularly limited, but examples of the material include one or more of copper (Cu), nickel (Ni), and stainless steel (SUS).

The current collecting layer 11 may have a thickness of about 0.1 to 50 µm.

The first coating layer 12 may be coated on a first surface of the current collecting layer 11 and react with lithium ions during charging of the all-solid-state battery so that lithium ions may be uniformly precipitated as a lithium metal or a lithium metal alloy on the current collecting layer 11.

The first coating layer 12 may include a metal component capable of forming an alloy with lithium. The metal capable of forming an alloy with lithium first coating layer may suitably include one or more selected from the group consisting of gold (Au), platinum (Pt), silver (Ag), magnesium (Mg), zinc (Zn), aluminum (Al), calcium (Ca), indium (In), and bismuth (Bi).

The first coating layer has a thickness of about 10 nm to 10 µm.

The second coating layer 13 may be coated on the first coating layer 12 to prevent the first coating layer 12 from being in direct physical contact with the solid electrolyte layer 30 and to prevent electrons from moving to the solid electrolyte layer 30. Accordingly, the second coating layer 13 may suitably include an insulating material or a material having less electronic conductivity than the first coating layer 12.

On the other hand, the second coating layer 13 positioned between the solid electrolyte layer 30 and the first coating layer 12 is required not to interfere with the movement of lithium ions. Accordingly, the second coating layer may suitably include a metal oxide having lithium-ion conductivity.

The second coating layer 13 may include a material having no or poor electronic conductivity and having good lithium-ion conductivity. The second coating layer may suitably include one or more selected from the group consisting of titanium dioxide (TiO₂), silicon dioxide (SiO₂), aluminum oxide (Al₂O₃), cerium oxide (CeO₂), magnesium oxide (MgO), calcium oxide (CaO), zirconium oxide (ZrO₂), and niobium oxide (Nb₂O₅).

The second coating layer 13 may not be decomposed even when it comes into contact with lithium ions. When manganese oxide (MnO) or the like meets lithium ions, an electrochemical decomposition reaction of MnO + Li⁺ -> Mn + Li₂O occurs. On the other hand, in the case of titanium dioxide (TiO₂), the original M-O bond is maintained as in a reaction formula of TiO₂ + Li⁺ -> LiₓTiO₂.

The second coating layer may suitably have a thickness of about 10 nm to 100 nm. When the thickness of the second coating layer 13 is less than about 10 nm, it is difficult to form the second coating layer 13, and the second coating layer 13 cannot prevent contact between the solid electrolyte layer 30 and the first coating layer 12 and cannot prevent electrons from moving to the solid electrolyte layer 30. On the other hand, when the thickness of the second coating layer 13 is greater than about 100 nm, it may be difficult for lithium ions to move to the first coating layer 12.

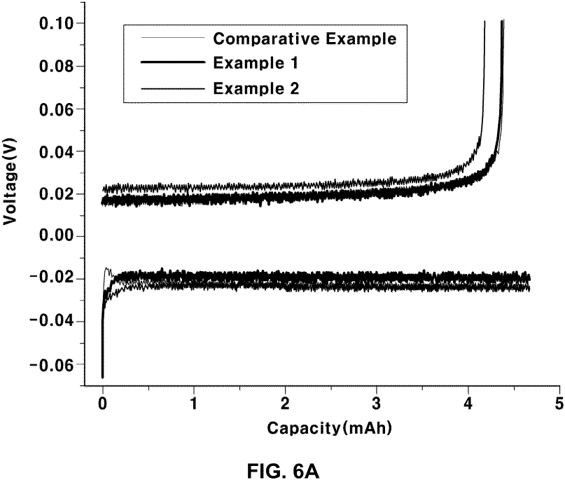

FIG. 3 shows a partial configuration of a charging process of an exemplary all-solid-state battery according to an exemplary embodiment of the present invention. For example, when the all-solid-state battery is charged, lithium ions pass through the solid electrolyte layer 20 and the second coating layer 13 having lithium-ion conductivity and then react with the first coating layer 12, thereby forming a lithium alloy layer 12′. Since the first coating layer 12 is made of a lithiophilic metal, the lithium ions may be uniformly deposited.

The second coating layer 13 may prevent the lithium alloy layer 12′ from coming into physical contact with the solid electrolyte layer 20 so that the lithium alloy layer 12′ does not react with the solid electrolyte layer 20.

In addition, since the second coating layer 13 has no or poor electronic conductivity, electrons cannot move to the solid electrolyte layer 20, so that lithium dendrites may not be formed on the surface of the solid electrolyte layer 20.

Therefore, the presence of the second coating layer 13 enables the all-solid-state battery to have improved lifespan and good cell performance. In addition, since the storage capacity for lithium ions may be increased compared to conventional anode-free all-solid-state batteries, an all-solid-state battery having a high energy density of about 1,000 Wh/L or greater can be formed.

Also provided is a method of forming the first coating layer 12 and the second coating layer 13 on the current collecting layer 11 is not particularly limited. For example, sputtering, spray coating, or slurry coating may be used as the method. In addition, the first coating layer 12 and the second coating layer 13 may be formed by different methods. The first and second coating layers may be formed by appropriate methods by taking into account the purpose, material, thickness, etc. thereof.

The solid electrolyte layer 20 is positioned between the cathode active material layer 30 and the anode current collector 10, thereby allowing lithium ions therebetween.

The solid electrolyte layer 20 may suitably include an oxide-based solid electrolyte or a sulfide-based solid electrolyte. However, it is preferable to use a sulfide-based solid electrolyte having high lithium-ion conductivity. The sulfide-based solid electrolyte is not particularly limited, but examples of the solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (here, m and n are positive integers, and Z is any one of Ge, Zn, and Ga), Li₂S—GeS₂, Li₂S—SiS₂—Li₃PO₄, Li₂S—SiS₂—LiₓMO_{y} (here, x and y are positive integers, and M is any one of P, Si, Ge, B, Al, Ga, and In), and Li_{1O}GeP₂S₁₂.

The cathode active material layer 30 may include a cathode active material, a solid electrolyte, a conductive material, a binder, and the like.

The cathode active material may include an oxide active material or a sulfide active material.

The oxide active material may include a rock salt layer-type active material such as LiCoO₂, LiMnO₂, LiNiO₂, LiVO₂, Li₁₊ₓNi_{⅓}Co_{⅓}Mn_{⅓}O₂, etc., a spinel-type active material such as LiMn₂O₄, Li(Ni_{0.5}Mn_{1.5})O₄, etc., an inverse spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock salt layer-type active material in which transition metals are partially substituted with dissimilar metals, such as LiNi_{0.8}Co_{(0.2-x})AlₓO₂ (0 < x < 0.2), a spinel-type active material in which transition metals are partially substituted with dissimilar metals, such as Li₁₊ₓMn_{2-x-y}M_{y}O₄ (M is at least one of Al, Mg, Co, Fe, Ni, and Zn, and 0 < x+y < 2), or a lithium titanate such as Li₄Ti₅O₁₂.

The sulfide active material may suitably include copper Chevrel, iron sulfide, cobalt sulfide, nickel sulfide, or the like.

The solid electrolyte may suitably include an oxide solid electrolyte or a sulfide solid electrolyte. However, it is preferable to use a sulfide-based solid electrolyte having high lithium-ion conductivity. The sulfide-based solid electrolyte is not particularly limited, but examples of the solid electrolyte may include Li₂S-P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (here, m and n are positive integers, and Z is any one of Ge, Zn, and Ga), Li₂S—GeS₂, Li₂S—SiS₂—Li₃PO₄, Li₂S—SiS₂—LiₓMO_{y} (here, x and y are positive integers, and M is any one of P, Si, Ge, B, Al, Ga, and In), and Li₁₀GeP₂S₁₂.

The conductive material may suitably include carbon black, conductive graphite, ethylene black, graphene, or the like.

The binder may an exemplary butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), or the like.

The cathode current collector 40 may be a plate-shaped, sheet-shaped, or thin-film substrate made of a conductive material. The cathode current collector 40 may suitably include aluminum (Al), stainless steel (SUS), or the like.

### EXAMPLE

Other forms of the invention will be described in more detail with reference to examples described below. The examples described below are presented only to help understanding of the present invention, and the scope of the present invention is not limited thereto.

### Example 1

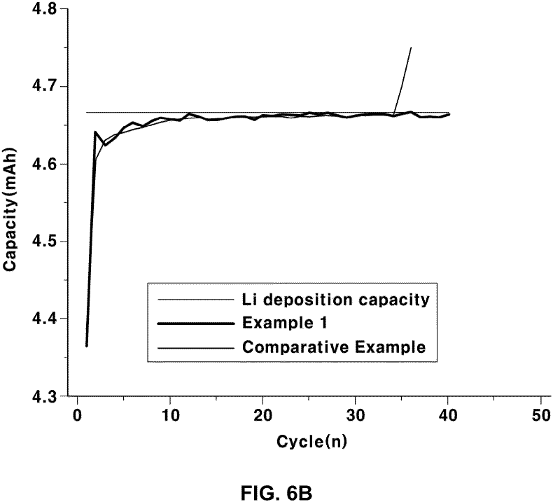

An anode current collector according to Example 1 was manufactured by a method described below. A magnesium thin plate was prepared as a current collecting layer. A first coating layer was formed by depositing magnesium (Mg), which is a metal capable of forming an alloy with lithium, to a thickness of about 300 nm on the current collecting layer. A second coating layer was formed by depositing titanium dioxide (TiO₂) on the first coating layer to a thickness of about 10 nm through sputtering. FIG. 4 shows a transmission electron microscopy-energy dispersive spectroscopy (TEM-EDS) analysis result of an anode current collector according to Example 1. As shown in FIG. 4, since titanium was evenly dispersed, it could be determined that the second coating layer was properly formed.

### Example 2

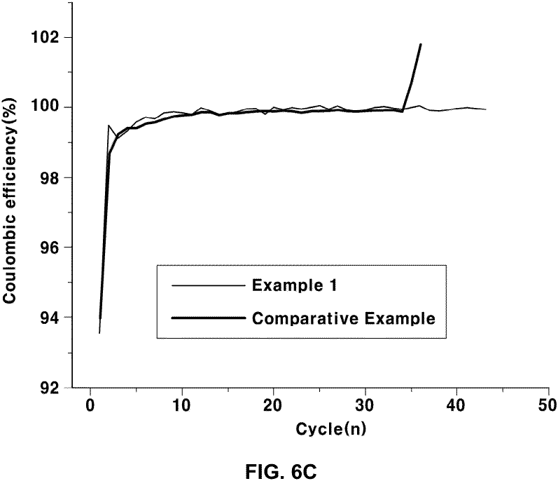

An anode current collector was manufactured in the same manner as in Example 1, except that the second coating layer was formed of silicon dioxide (SiO₂). FIG. 5 shows a transmission electron microscopy-energy dispersive spectroscopy (TEM-EDS) analysis result of an anode current collector according to Example 2. As shown in FIG. 5, since magnesium, silicon, and oxygen were all evenly dispersed, the first coating layer and the second coating layer were all uniformly formed.

### Comparative Example

An anode current collector was prepared in the same manner as in Example 1, except that there was no second coating layer.

### Experimental Example 1

Half cells including the anode current collectors according to Example 1, Example 2, and Comparative Examples were manufactured, respectively. Each half cell was charged and discharged at a current density of 1.175 mA/cm² and a deposition capacity of 3.52 mAh/cm², and the performance thereof was evaluated at a temperature of about 30° C.

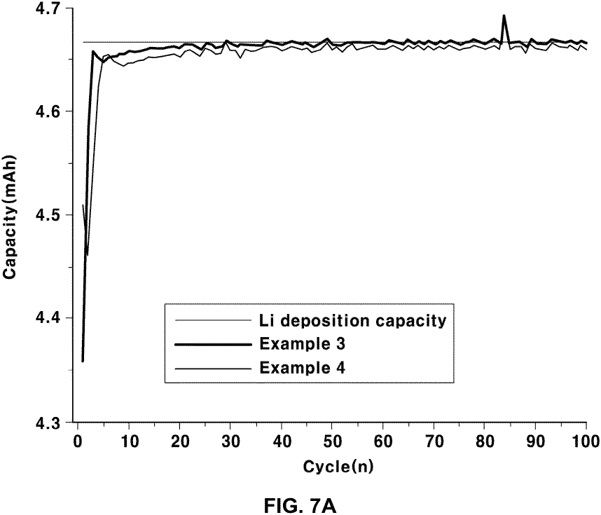

FIG. 6A shows the results of the first charge and discharge cycle of each of the half cells according to Example 1, Example 2, and Comparative Example. As such, lithium ions could pass through the second coating layer in light of the fact that the half-cells of Examples 1 and 2 are properly charged and discharged.

FIG. 6B shows the results of evaluation of the lifespan of each of the half cells according to Example 1 and Comparative Example. As shown in FIG. 6B, both the half-cells were stably charged and discharged up to 30 cycles, but the half-cell of Comparative Example showed a short circuit phenomenon in which the amount of lithium desorption is larger than the amount of lithium deposition from the thirty third cycle. The half cell of Example 1 was stably charged and discharged even after the thirtieth cycle.

FIG. 6C shows the results of evaluation of the coulombic efficiency for each charge and discharge cycle of each of the half cells according to Example 1 and Comparative Example. As shown in FIG. 6C, unlike the half cell of Comparative Example, the coulombic efficiency of the half cell of Example 1 was maintained substantially the same as the initial charge/discharge even when the number of charge/discharge cycles exceeds 30.

### Example 3

An anode current collector was prepared in the same manner as in Example 1, except that the thickness of the second coating layer was adjusted to 50 nm.

### Example 4

An anode current collector was prepared in the same manner as in Example 1, except that the thickness of the second coating layer was adjusted to 100 nm.

### Experimental Example 2

Half cells including the anode current collectors according to Example 3 and Example 4 were manufactured, respectively. Each half cell was charged and discharged at a current density of 1.175 mA/cm² and a deposition capacity of 3.52 mAh/cm², and the performance thereof was evaluated at a temperature of about 30° C.

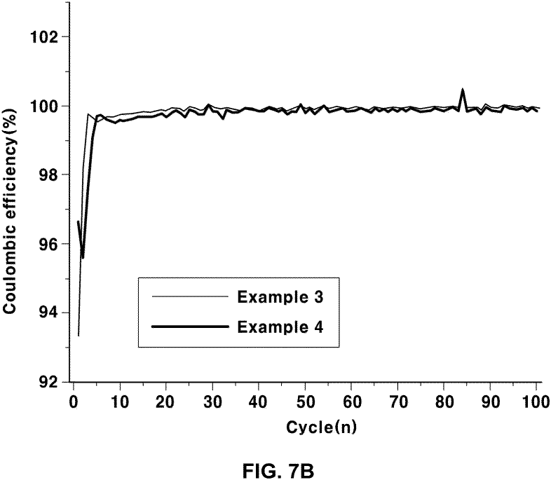

FIG. 7A shows the results of evaluation of the lifespan of each of the half cells according to Examples 3 and 4, and both the half cells could be charged and discharged more than 100 times.

FIG. 7B shows the results of evaluation of the coulombic efficiency for each charge and discharge cycle of each of the half cells according to Examples 3 and 4, and both the half-cells maintained the initial coulombic efficiency until the number of charge/discharge cycles exceeds 100.

Although exemplary embodiments according to the present invention have been described for illustrative purposes, those skilled in the art will appreciate that various modifications, additions and substitutions are possible, without departing from the scope and spirit of the invention as disclosed in the appended claims

What is claimed:

1. An anode current collector for an all-solid-state battery, comprising:
a current collecting layer;
a first coating layer disposed on a first surface of the current collecting layer and comprising a metal component capable of forming an alloy with lithium; and
a second coating layer disposed on the first coating layer and having less electronic conductivity than the first coating layer.

2. The anode current collector of claim 1, wherein the first coating layer comprises one or more selected from the group consisting of gold (Au), platinum (Pt), silver (Ag), magnesium (Mg), zinc (Zn), aluminum (Al), calcium (Ca), indium (In), and bismuth (Bi).

3. The anode current collector of claim 1, wherein the first coating layer has a thickness of about 10 nm to 10 µm.

4. The anode current collector of claim 1, wherein the second coating layer comprises a metal oxide having lithium-ion conductivity.

5. The anode current collector of claim 1, wherein the second coating layer comprises one or more selected from the group consisting of titanium dioxide (TiO₂), silicon dioxide (SiO₂), aluminum oxide (Al₂O₃), cerium oxide (CeO₂), magnesium oxide (MgO), calcium oxide (CaO), zirconium oxide (ZrO₂), and niobium oxide (Nb₂O₅).

6. The anode current collector of claim 1, wherein the second coating layer has a thickness of about 10 nm to 100 nm.

7. An all-solid-state battery comprising:
the anode current collector of claim 1;
a solid electrolyte layer disposed on the anode current collector;
a cathode active material layer disposed on the solid electrolyte layer; and
a cathode current collector disposed on the cathode active material layer,
wherein the second coating layer of the anode current collector is in contact with the solid electrolyte layer.

8. The all-solid-state battery of claim 7, wherein when the all-solid-state battery is charged, lithium ions react with the first coating layer of the anode current collector to form a lithium alloy layer.

9. A vehicle comprising an all-solid-state battery of claim 7.
